(19) United States
(12) Patent Application Publication
(10) Pub. No.: US 2022/0410802 A1
(43) Pub. Date: Dec. 29, 2022

(54) SYSTEM AND METHOD FOR AIDING A PERSON IN LOCATING VEHICLES AND EQUIPMENT

(71) Applicants: Sarah Aladas, Lowell, MA (US); Ilkka Tuomas Kalervo Pirttimaa, Helsinki (FI)

(72) Inventors: Sarah Aladas, Lowell, MA (US); Ilkka Tuomas Kalervo Pirttimaa, Helsinki (FI)

(21) Appl. No.: 17/850,920

(22) Filed: Jun. 27, 2022

Related U.S. Application Data
(60) Provisional application No. 63/215,652, filed on Jun. 28, 2021.

(51) Int. Cl. B60Q 9/00; B60W 50/16

(52) U.S. Cl. CPC B60Q 9/008; B60W 50/16

(57) ABSTRACT

A system comprising a client device and a quiet vehicle proximity alert device. The quiet vehicle proximity alert device is associated with a vehicle and configured to broadcast a set of data with respect to a status of the vehicle. The client device is configured to issue a first notification on receiving the set of data if one or more data from the set of data is found to match one or more pre-specified conditions. A second notification is issued by the quiet vehicle proximity alert device on receiving a request for the second notification transmitted by the client device. The second notification comprises an acoustic notification and a driver alert notification. The acoustic notification is dynamically adjusted in real-time by the quiet vehicle proximity alert device corresponding to the status of the vehicle and a status of the client device.

### CROSS-REFERENCE TO RELATED APPLICATIONS

This application claims the benefit of U.S. Provisional Application No. 63/215,652, filed Jun. 28, 2021, the contents of which are incorporated herein by reference.

### FIELD OF THE INVENTION

The present invention relates to systems for aiding visually impaired persons in increasing situational awareness. More particularly, the present invention relates to a system that enables a visually impaired person to locate a quiet vehicle.

### BACKGROUND OF THE INVENTION

In recent times, use of electric vehicles and electric hybrid vehicles is being promoted widely as alternatives to internal combustion engine (ICE) driven vehicles to reduce air pollution and as a sustainable transportation solution. Absence of internal combustion engine makes the electric vehicles much quieter than the traditional ICE driven vehicles. Even the ICE driven vehicles are also becoming less noisy with use of efficient sound absorbing insulations and other technologies. While quieter vehicles can contribute to reduction of sound pollution, lack of the familiar sound made by the internal combustion engine in vehicles also has its own downsides. People are accustomed to identifying the presence of nearby vehicles by listening to the noise made by the vehicle engines. So, absence of this familiar sound makes it difficult for a pedestrian to become aware of the presence of a vehicle in the vicinity and that may pose a risk to both the pedestrian and the vehicle. This problem is even more serious for those pedestrians who are visually impaired. Due to the quieter operation, it is virtually impossible for visually impaired persons to detect an electric vehicle, assess its distance and direction of travel correctly and early enough to avoid being hit.

To overcome this problem authorities in many places/jurisdictions have made it mandatory to install warning sound devices at electric vehicles. The warning sounds can be driver initiated or automatic depending on the situation. But, continuous sounding of such warning may become annoying and unwanted, especially when the vehicles are driven in an indoor environment. Also, making of warning sound by a stationary silent vehicle is not always mandatory as per the laws.

Thus, there exists a requirement for a system and method for detecting the presence of quiet vehicles in the vicinity of a person on need basis.

### OBJECTS OF THE INVENTION

An object of the present invention is to provide a system and method for enhancing spatial awareness for a visually impaired person.

Another object of the present invention is to provide a system that assists a visually impaired person to acquire the knowledge of the presence of potential threats of moving objects in his/her surroundings.

Yet another object of the present invention is to provide a system and method for enabling a visually impaired person to remotely activate an acoustic and/or visual alert in a nearby object.

Still another object of the present invention is to provide a system and method for alerting a vehicle to the presence of a nearby visually impaired person.

Another object of the present invention is to provide a system and method for assisting a person to locate a selected vehicle.

Yet another object of the present invention is to provide a system and method for receiving status and types of nearby vehicles.

Another object of the present invention is to provide a system and method for need based/on-demand activation of acoustic guidance on a silent vehicle.

These as well as other objects of the present invention are apparent upon inspection of this specification, including the drawings attached hereto.

### SUMMARY OF THE INVENTION

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The present invention is directed to a system and method for a quiet vehicle proximity alert system. The present invention enables activation of warning sound or acoustic guidance on a user selected vehicle remotely from a client device on-demand or on need basis. The system comprises a quiet vehicle proximity alert device and a client device. The quiet vehicle proximity alert device installed on a vehicle is configured to acquire one or more information on the status and type of the vehicle using its own sensors and/or from the vehicle control system. Wireless messages having this information are continuously broadcasted by the quiet vehicle proximity alert device. Whenever a client device carried by a user comes within a specified distance from the quiet vehicle proximity alert device installed on a vehicle, the client device reads the wireless messages and detects the presence of the vehicle in the vicinity of the user and issues an audible/visual/tactile notification from the client device. The user is allowed to select one or more detected vehicles for playing an acoustic guidance or emitting a warning sound from the vehicle. This acoustic guidance or warning sound helps a visually impaired person to detect a quiet vehicle's presence in the vicinity and assess its distance and direction to take appropriate action on time.

### BRIEF DESCRIPTION OF DRAWINGS

The accompanying drawings, which are incorporated herein and form a part of the specification, illustrate the present invention and, together with the description, further serve to explain the principles of the invention and to enable a person skilled in the relevant art to make and use the invention. The present invention will become more fully understood from the detailed description given herein below and the accompanying drawings which are given by way of illustration only, and thus are not limitative of the present invention, and wherein:

FIG. 1 illustrates a general architecture of a quiet vehicle proximity alert system in accordance with an embodiment of the present invention;

FIG. 2 shows the system architecture of a client device that operates in accordance with one embodiment of the present invention;

FIG. 3 shows a schematic view of interaction between an installed quiet vehicle proximity alert device and a remote client device as per an embodiment of the present invention;

FIG. 4 illustrates a non-limiting exemplary use case of the quiet vehicle proximity alert system in accordance with an embodiment of the present invention; and

FIG. 5 illustrates a flowchart depicting the general steps associated with the method for the quiet vehicle proximity alert system in accordance with an embodiment of the present invention.

### DETAILED DESCRIPTION OF THE INVENTION

The following description is presented to enable any person skilled in the art to make and use the invention, and is provided in the context of particular applications of the invention and their requirements. Various modifications to the disclosed embodiments will be readily apparent to those skilled in the art and the general principles defined herein may be applied to other embodiments and applications without departing from the scope of the present invention. Thus, the present invention is not intended to be limited to the embodiments shown, but is to be accorded the widest scope consistent with the principles and features disclosed herein.

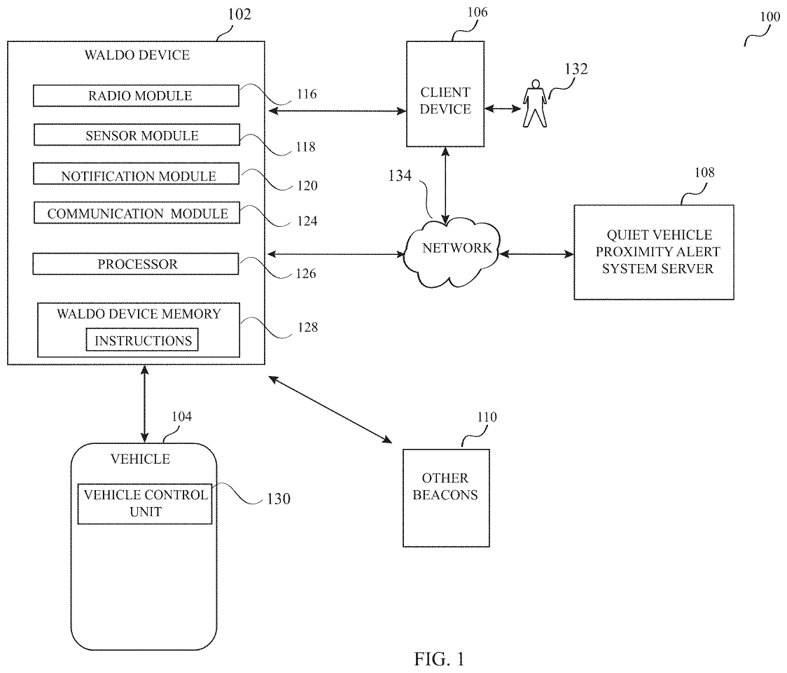

FIG. 1 illustrates, in general, an environment depicting an exemplary configuration of the quiet vehicle proximity alert system 100. The system 100 comprises a quiet vehicle proximity alert device 102 installed on a vehicle 104, a client device 106, a quiet vehicle proximity alert system server 108 and, optionally, one or more Bluetooth message transmitters 110.

The quiet vehicle proximity alert device 102 is hereinafter referred to, alternatively and interchangeably, as “WALDO”. As used herein, the term “vehicle” refers to any vehicle or equipment which either makes little or less sound or noise while in operation or which may require playing an acoustic notification for aiding persons to detect the presence of such vehicle or equipment in their vicinity.

With reference to FIGS. 1, 3 and 4, the quiet vehicle proximity alert device 102 is configured to be associated with a vehicle 104 to acquire a set of data on a status of the vehicle 104. The association between the quiet vehicle proximity alert device 102 and a vehicle 104 can be established, for example, by installing the quiet vehicle proximity alert device 102 on a vehicle 104 as an integral part of the vehicle 104 or the vehicle 104 being retrofitted with it. In a preferred embodiment, the quiet vehicle proximity alert device 102 is operably and functionally connected to one or more components of the vehicle 104 in order to acquire the set of data required for determining a status of the vehicle 104. For example, the quiet vehicle proximity alert device 102 can be connected to a telematics unit/vehicle control unit 130 of the vehicle 104 to acquire such data. Status of the vehicle 104 may correspond to identity of the vehicle, distance between the vehicle and the client device (determined based on received signal strength indicator—RSSI, for example), type of the vehicle, status on occupancy of the vehicle, status on engine/motor off or on condition of the vehicle, status on whether the vehicle is moving or stationary, speed of the vehicle, direction of travel of the vehicle, status of horn of the vehicle, status on safety beacon light with audio system and lamps of the vehicle. Accordingly, the data acquired through the unit 130 may comprise data on engine/motor off or on condition, acceleration, speed, direction of travel, occupancy, status of vehicle horn, safety beacon light with audio system and vehicle lamps etc. of the vehicle 104. In some embodiments, the association between the quiet vehicle proximity alert device 102 and a vehicle 104 may not require any direct communicable connection with the vehicle 104 and the quiet vehicle proximity alert system 102 may acquire the set of data required to determine one or more parameters of the status of the vehicle 104 by using its own sensors. For example, the quiet vehicle proximity alert device 102 may acquire data on speed and direction of travel of the vehicle 104 using its own sensors.

The quiet vehicle proximity alert device 102, as shown in FIG. 1, comprises a radio module 116, a sensor module 118, a notification module 120, a communication module 124, a processor 126 and a device memory 128.

The radio module 116 of quiet vehicle proximity alert device 102 is configured to generate wireless messages of various protocols. The radio module 116 may further comprise a Bluetooth Low Energy (BLE) module, a Bluetooth Classic module, a Wi-Fi module and a Ultra-wideband (UWB) module. Each of these modules may include the necessary hardware, e.g., processor, memory and associated circuitry, and software necessary to perform communication by way of Bluetooth Low Energy, Bluetooth Classic, Wi-Fi and UWB respectively. Settings for these modules may be controlled by way of setting instructions 129 stored in the memory 128.

In a preferred embodiment, the processor 126 may cause the communication module 124 to broadcast the messages or advertising packets generated by the radio module 116. The messages/advertising packets may comprise a unique identifier (universally unique identifier—UUID, for example) which identifies the quiet vehicle proximity alert device 102 and associated data. The associated data includes at least a data indicative of the vehicle status and type, Global Positioning System (GPS) or other geo-location receiver data, gyroscope data, accelerometer data, compass data and any other data acquired from the vehicle control unit 130.

The sensor module 118 comprises sensors such as accelerometer, compass, gyroscope, proximity sensor, optical sensor, temperature sensor and infrared sensor etc. The notification module 120 comprises one or more output devices that enable presentation of media content, including one or more speakers and/or one or more visual displays/light alarms. In some implementations, the notification module 120 may also include one or more input devices, including user interface components that facilitate user input such as a keyboard, a voice-command input unit, a touch screen display/pad, a gesture capturing camera, or other input buttons or controls.

The communication module 124 of the quiet vehicle proximity alert device 102 can act as a transceiver to transmit (including continuous broadcasting) and receive wireless signals/messages. The communication module 124 enables establishment of a wireless communication link for the bidirectional flow of data with the quiet vehicle proximity alert device 102 wirelessly.

The quiet proximity vehicle alert device 102 is also configured to receive wireless messages including BLE beacon messages and act on received message information. The quiet proximity vehicle alert device 102 is also configured to provide information to another device which can help in determination of the location of the quiet proximity vehicle alert device 102 using various methods such as localization technique.

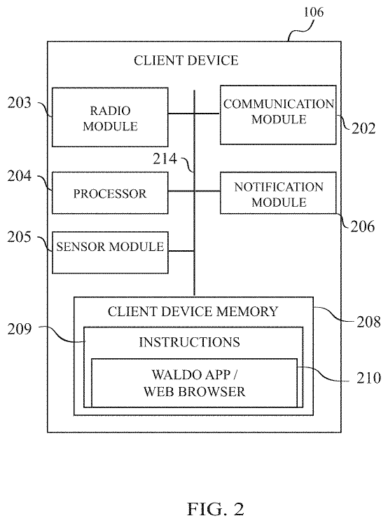

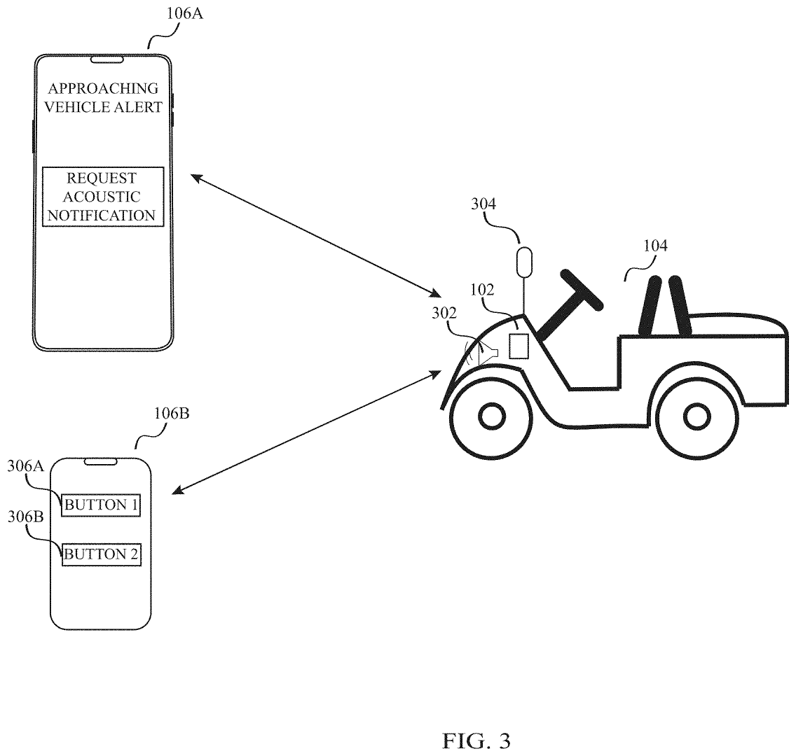

The client device 106 of the present invention is a portable mobile computing device which can be a custom made remote control device (such as 106B of FIG. 3) or a smartphone (such as 106A of FIG. 3) or a similar computing device. FIG. 2 illustrates a schematic diagram of an exemplary embodiment of the client device 106 that may be used for implementation of the present disclosure. The client device 106 comprises a communication module 202, a Radio Module 203, a processor 204, a sensor module 205, a notification module 206 and a client device memory 208. The client device 106 may include components more or less than those shown in FIG. 2. For example, the client device 106 may further comprise location module (such as a Global Positioning System module). The components of the client device 106 are communicably connected to each other through bus 214.

The client device memory 208 includes one or more sets of instructions 209 including application 210. The application or “app” is a computer program that may be downloaded and installed on computing devices using methods known in the art. It can also be a set of instructions programmed on the hardware of the client device or a pre-loaded computer program or firmware or any such native application supplied with the client device. Hereinafter, the app or mobile app/native application of the present invention is referred to as the “WALDO app”. In general, instructions 209 may, when loaded into processor 204 and executed, transform the client device 106 from a general-purpose computing device into a special-purpose computing device 106 customized to facilitate quiet vehicle proximity alerting method.

The user interface of the client device 106 may comprise a graphical user interface with the provision for a keyboard and/or a user interface with built-in buttons such as buttons 306A and 306B of the remote 106B version of the client device 106 of FIG. 3 to receive touch input. The client device 106 may comprise a voice input device, a motion input device for detecting non-touch gestures and other motions of a user, and other comparable input devices and associated processing elements capable of receiving user input from a user. Output devices such as speakers, haptic devices, and other types of output devices may also be included in client device 106. The sensor module 205 may comprise one or more sensors such as accelerometer, gyroscope, magnetometer, GPS module, radar module, light laser scanning module, barometer, proximity sensor and ambient light sensor etc.

The communication module 202 is configured to facilitate bidirectional transmission of data. The communication module 202 can include one or more wireless modules that enables a wireless communication link for the bidirectional flow of data from and to the device wirelessly. The Radio module 203 can remain in an active state or idle state. But, even when in the idle state the Radio module 203 scans for incoming Bluetooth Low Energy (BLE) beacons or advertisement messages of other protocols such as Ultra-Wideband (UWB) from other devices. Once the Radio module 203 receives a wireless message of interest it turns itself to an active state and wakes up the application on the client device 106.

The quiet vehicle proximity alert system server 108 of FIG. 1 may include a processor, memory, and communication device. The memory may store various computer programs or instructions to be executed by the processor. It may store, for example, instructions for generating and assigning UUIDs. The server 108 may comprise the necessary hardware and/or software to enable communication through network 134. The processor can execute programs and instructions so as to operate the server 108. The network connection 134 depicted in FIG. 1 includes a local area network (LAN), wide area network (WAN), and a wireless telecommunications network, but may also include other networks.

The other beacons 110 shown in FIG. 1 are commonly used beacons, including BLE beacons which send out messages/advertisement at regular intervals and which can be used for determination of location information.

FIG. 3 shows the quiet vehicle proximity alert device 102 installed on a vehicle 104. In one embodiment, the quiet vehicle proximity alert device 102 operates as an independent and self-sufficient unit which can be simply affixed/attached to the vehicle 104 and which does not require any other support/connection from/with the vehicle. In some other embodiments, installation of the quiet vehicle proximity alert device 102 may involve connecting the device 102 to the power source of the vehicle, to the vehicle control unit 130, to beacon lamp 304 or other light sources of the vehicle and also to the vehicle horn 302. In other embodiments, all or some of the components of the quiet vehicle proximity alert device 102 may come embedded with the hardware of the vehicle 104.

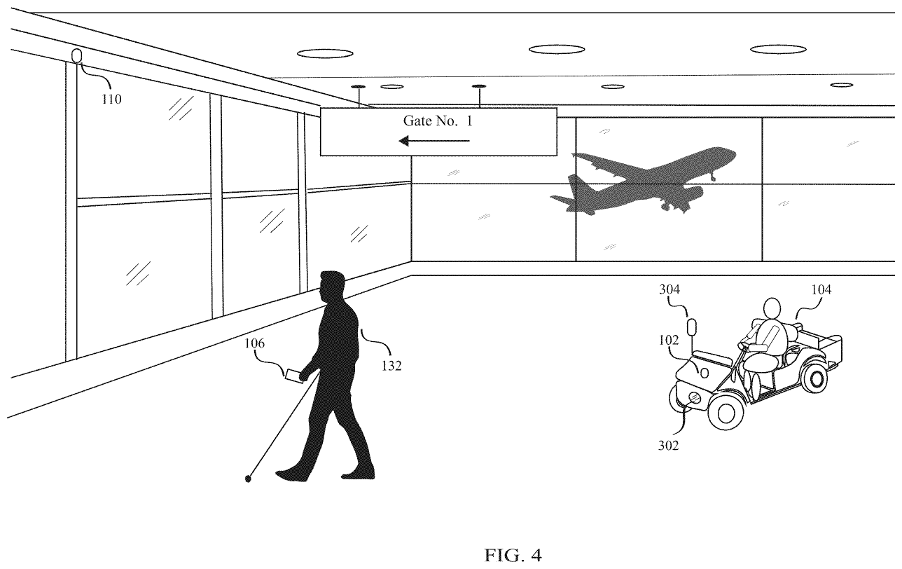

The present invention is now described with the help of an exemplary implementation scenario as depicted in FIG. 4. In this example, the quiet vehicle proximity alert device 102 is installed on one or more electric carts/vehicles 104 which are commonly used at airport terminals for indoor transportation of passengers and luggage from one place to another. The visually impaired person 132 of this example is carrying a client device 106 which can be a smartphone/tablet/smart watch 106A or a custom made remote control device 106B. There are several situations where the present invention may help in enhancing situational awareness of the visually impaired person 132 with regard to the stationary and moving quiet vehicles 104 present in the vicinity.

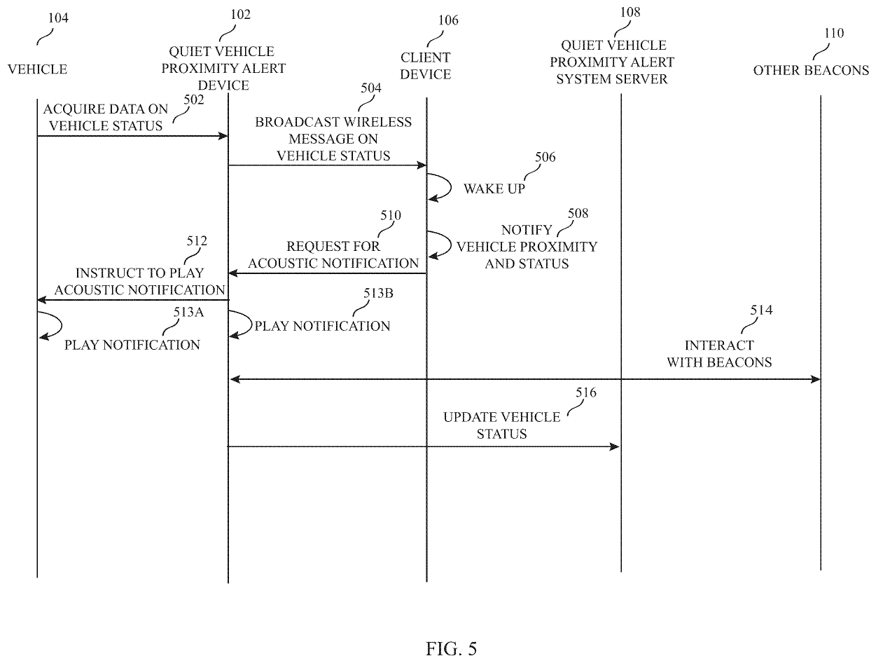

The quiet vehicle proximity alert device 102 keeps on acquiring the data related to the status of the vehicle 104, as in step 502 of FIG. 5, from the telematics unit/vehicle control unit 130 of the vehicle 104 and/or with the use of sensor module 118 of the quiet vehicle proximity alert device 102 attached to the vehicle 104. Data on status of the vehicle may comprise data on status of the engine/motor off or on condition, location information, acceleration, speed, direction of travel, status of vehicle horn, safety beacon light with audio system and vehicle lamps, vehicle type and occupancy/availability etc. of the vehicle 104.

The quiet vehicle proximity alert device 102 keeps on broadcasting wireless messages such as BLE advertising packets and/or UWB messages as in step 504 of FIG. 5. The wireless messages comprise data on identification of the quiet vehicle proximity alert device 102, type of the vehicle and status of the vehicle, among others. On the other hand, the processor 204 of the client device 106 is configured to cause the Radio module 203 to scan for the unique identification (UUID, for example) by way of Bluetooth Low Energy or UWB even when the WALDO app is not running on the client device 106. So, as soon as the client device 106 carried by the user 132 comes within the range of the wireless messages being broadcasted by the quiet vehicle proximity alert device 102, the processor 204 determines whether the received unique identification matches one of those stored in the memory 208 of the client device. If the unique identification matches i.e. a quiet vehicle proximity alert device 102 is detected, the WALDO app and/or the client device 106 are woken up or alerted as in step 506 of FIG. 5.

The above-mentioned scanning process goes on continuously at the client device 106 in the background or in the foreground and the user 132 is notified (first notification) about the presence of the detected one or more quiet vehicle proximity alert devices 102 in the vicinity as in step 508 of FIG. 5 if one or more data in the set of data received from the quiet vehicle proximity alert device 102 is found to exceed/fall within/match a pre-specified criterion/condition/range/level/limit. For example, if the pre-specified criterion is such that moving vehicles and not stationary vehicles require attention then client device 106 checks the received set of data and issues the first notification only when the set of data indicates that the vehicle is moving. Similarly, a trigger for the first notification could be the direction of travel of the vehicle or the user (vehicles moving toward the client device or vice-versa, for example). Further examples of pre-specified criterion may be an identity of the vehicle, a distance between the vehicle and the client device, a type of the vehicle, a status on occupancy of the vehicle, a status on engine off or on condition of the vehicle, speed of the vehicle, a status of horn of the vehicle, a status on safety beacon light with audio system and lamps of the vehicle etc. Accordingly, the status notification or the first notification may comprise information on identity of the vehicle, distance between the vehicle and the client device, type of the vehicle (passenger carrier or luggage carrier, for example), status on occupancy (vehicle is occupied or not), status on whether the engine/motor of the vehicle is in off or on condition, status on whether the vehicle is moving or stationary, speed of the vehicle, direction of travel of the vehicle, status of the vehicle horn (whether playing any acoustic notification or not), safety beacon light with audio system and vehicle lamps etc.

The first notification can be made through one or more notification options available on the client device 106. The one or more notification options may comprise an audible notification of the status (the WALDO app reads out the status information loudly, for example), a visual notification and a tactile notification.

The user 132 may come across many probable scenarios. For example, the user 132 may be heading toward a vehicle 104 which is moving or stationary, a vehicle 104 may be approaching the user 132 or the user 132 wants to avail the services of the vehicle 104. In all such scenarios, the user 132 may face multiple problems when the user 132 is visually impaired. The present invention equips a visually impaired person to successfully and safely deal with all these situations. The user 132 gets notified about the presence of one or more such vehicles on the client device 106 being carried by the user 132 which makes the user 132 aware of the situation. If the user 132 wants to know the location and other related information of one or more detected vehicle 104 then the user 132 may make a request for activation of a second notification comprising an acoustic notification (which may also include visual and tactile notification) and a driver alert notification on the one or more of the detected vehicles 104 as in step 510 of FIG. 5. The request for the second notification transmitted by the client device 106 may also comprise information on the status of the client device 106 such as the unique identity of the client device, direction of travel of the client device 106, speed of travel of the client device 106 etc. The client device 106 is configured to make the request for the second notification on receiving a voice command, a touch command (pressing of a button of client device 106B, for example) or through a gesture/motion command. The communication modules 124 and 202 handle the communications and, if required, establish a communication channel between a selected vehicle 104 and client device 106.

On receiving the request for the second notification, the quiet vehicle proximity alert device 102 checks the status of the respective one or more selected vehicles 104 and takes appropriate action, including issuing instruction to play acoustic notification (an acoustic notification with information on type, status, distance, direction etc., for example) at the vehicle 104, as in step 512 of FIG. 5. For example, if the probability of the vehicle 104 and the user 132 coming in the path of each other is high then the quiet vehicle proximity alert device 102 will initiate playing of an acoustic notification either through the built-in speaker of the quiet vehicle proximity alert device 102, as in step 513B of FIG. 5, or through the built-in speaker/horn of the vehicle 104 as in step 513A of FIG. 5. In a preferred embodiment, the loudness, pace and type of the sound being played as acoustic notification can be changed dynamically in real time depending on the status of the vehicle 104 and the client device 106 such as relative distance between the vehicle 104 and the client device 106 (increase the volume or quicken the sound beats gradually as the client device 106 and vehicle 104 come closer to each other, for example) or speed or direction of travel of the vehicle 104 and the client device 106 (increase the volume or quicken the sound beats when the client device 106 and vehicle 104 fall on the same path of travel against each other or when they are likely to cross path, for example). This acoustic notification of the second notification helps the user 132 to estimate the location, direction and distance of the selected one or more vehicles 104 with respect to the location of the user 132. Additionally, the driver of the vehicle 104 may be alerted about the presence of a visually impaired person in the vicinity by way of the audio/visual driver alert notification. The second notification can be configured to be customized as per a selection made from the client device 106 or from the quiet vehicle proximity alert device 102. In instances where a vehicle is autonomous or driverless, the user 132 may make a request for playing a user specific customized acoustic notification at the selected vehicle 104. For example, the quiet vehicle proximity alert device 102 may receive the name of the user 132 from the client device 106 or from the server 108 and play the name as part of the acoustic second notification so that the user 132 can identify and locate the exact vehicle the user 132 selected for availing a transport service. In another example of customized second notification, a user selected piece of music/sound may be played as the second notification. In a preferred embodiment, the second notification is issued/played as long as one or more data from the set of data sent by the quiet vehicle proximity alert device satisfy the one or more pre-specified conditions or as desired by the user. For example, if one of the pre-specified conditions is possibility of crossing travel paths of client device 104 and vehicle 106, then the second notification is issued or played as long as the client device 104 and the vehicle 106 move in the direction of crossing paths and the second notification is stopped or the sound/pace of the sound being played is changed if either the user carrying the client device 104 or the vehicle 106 deviates from the potential collision course.

In some embodiments, the quiet vehicle proximity alert device 102 may also help in determination of a location of a vehicle 104 for other users of the system. For example, the quiet vehicle proximity alert device 102 may interact with one or more other BLE beacons 110 installed at different locations of a place (such as beacon 110 shown in FIG. 4) for indoor positioning of the vehicle 104 as in step 514 of FIG. 5. The quiet vehicle proximity alert device 102 may also communicate such location information and update the vehicle status to the remote server 108 over the network 134 as in step 516 of FIG. 5.

Thus, the present invention enables a visually impaired person to use the acoustic cues to determine the location, direction, speed and other information with respect to a silent vehicle to avoid potentially dangerous situations and also to find and use the services of autonomous vehicles.

What is claimed is:

1. A method comprising:
associating a quiet vehicle proximity alert device with a vehicle;
broadcasting by said quiet vehicle proximity alert device a set of data with respect to a status of said vehicle;
issuing a first notification by a client device on receiving said set of data if one or more data from said set of data is found to match one or more pre-specified conditions;
transmitting by said client device a request for a second notification as per a selection; and
issuing said second notification by said quiet vehicle proximity alert device on receiving said request for said second notification.

2. The method of claim 1, wherein said quiet vehicle proximity alert device is configured to be operably and functionally connected to one or more components of said vehicle for said association in order to acquire said set of data.

3. The method of claim 1, wherein said status of said vehicle corresponds to an identity of said vehicle, a distance between said vehicle and said client device, a type of said vehicle, a status on occupancy of said vehicle, a status on engine off or on condition of said vehicle, a status on whether said vehicle is moving or stationary, a speed of said vehicle, a direction of travel of said vehicle, a status of a horn of said vehicle, a status on a safety beacon light with audio system and lamps of said vehicle.

4. The method of claim 1, wherein said first notification comprises information on said status of said vehicle.

5. The method of claim 1, wherein said one or more pre-specified conditions include a distance between said vehicle and said client device, a type of said vehicle, a status on occupancy of said vehicle, a status on engine off or on condition of said vehicle, a status on whether said vehicle is moving or stationary, a speed of said vehicle, a direction of travel of said vehicle, a status of horn of said vehicle, a status on safety beacon light with audio system and lamps of said vehicle.

6. The method of claim 1, wherein said second notification comprises an acoustic notification and a driver alert notification.

7. The method of claim 6, wherein said acoustic notification is dynamically adjusted in real-time by said quiet vehicle proximity alert device corresponding to said status of said vehicle and a status of said client device.

8. The method of claim 1, wherein said second notification is configured to be customized as per a selection made from said client device or from said quiet vehicle proximity alert device.

9. The method of claim 1, wherein said second notification is issued as long said one or more data from the set of data sent by the quiet vehicle proximity alert device satisfy said one or more pre-specified conditions.

10. The method of claim 1, wherein said client device is configured to make said request for said second notification on receiving a voice command, a touch command and through a gesture command.

11. A system comprising:
a quiet vehicle proximity alert device associated with a vehicle, said quiet vehicle proximity alert device being configured to broadcast a set of data with respect to a status of said vehicle; and
a client device configured to issue a first notification on receiving said set of data if one or more data from said set of data is found to match one or more pre-specified conditions;
wherein a second notification is issued by said quiet vehicle proximity alert device on receiving a request for said second notification transmitted by said client device.

12. The system of claim 11, wherein said quiet vehicle proximity alert device is configured to be operably and functionally connected to one or more components of said vehicle for said association in order to acquire said set of data.

13. The system of claim 11, wherein said status of said vehicle corresponds to an identity of said vehicle, a distance between said vehicle and said client device, a type of said vehicle, a status on occupancy of said vehicle, a status on engine off or on condition of said vehicle, a status on whether said vehicle is moving or stationary, a speed of said vehicle, a direction of travel of said vehicle, a status of a horn of said vehicle, a status on a safety beacon light with audio system and lamps of said vehicle.

14. The system of claim 11, wherein said first notification comprises information on said status of said vehicle.

15. The system of claim 11, wherein said one or more pre-specified conditions include a distance between said vehicle and said client device, a type of said vehicle, a status on occupancy of said vehicle, a status on engine off or on condition of said vehicle, a status on whether said vehicle is moving or stationary, a speed of said vehicle, a direction of travel of said vehicle, a status of horn of said vehicle, a status on safety beacon light with audio system and lamps of said vehicle.

16. The system of claim 11, wherein said second notification comprises an acoustic notification and a driver alert notification.

17. The system of claim 16, wherein said acoustic notification is dynamically adjusted in real-time by said quiet vehicle proximity alert device corresponding to said status of said vehicle and a status of said client device.

18. The system of claim 11, wherein said second notification is configured to be customized as per a selection made from said client device or from said quiet vehicle proximity alert device.

19. The system of claim 11, wherein said second notification is issued as long said one or more data from the set of data sent by the quiet vehicle proximity alert device satisfy said one or more pre-specified conditions.

20. The system of claim 11, wherein said client device is configured to make said request for said second notification on receiving a voice command, a touch command and through a gesture command.
